(19) United States
(12) Patent Application Publication
(10) Pub. No.: US 2010/0015563 A1
(43) Pub. Date: Jan. 21, 2010

(54) Device for the Levitated Guidance of Web Shaped Material

(75) Inventors: Winfried Sommereisen, Aachen (DE); Klaus-Dieter Oeschger, Laufenburg (DE)

Correspondence Address: PROSKAUER ROSE LLP, ONE INTERNATIONAL PLACE, BOSTON, MA, 02110, US

(73) Assignee: Otto Junker GmbH, Simmerath (DE)

(21) Appl. No.: 12/513,429

(22) PCT Filed: Nov. 2, 2007
(86) PCT No.: PCT/EP2007/061819

§ 371 Date: Sep. 18, 2009

(30) Foreign Application Priority Data
Nov. 6, 2006 (DE) 10 2006 052 521.3
Nov. 30, 2006 (DE) 10 2006 056 518.5

(51) Int. Cl. F27B 17/00; B65H 23/24; F27B 9/30; F27B 5/14

(52) U.S. Cl. 432/58; 242/548.4; 432/200

(57) ABSTRACT

A device for the levitated guidance of web-shaped material, particularly metal strips, with at least one first radial fan and with at least one flow channel system that is assigned to the at least one first radial fan provides that the at least one first radial fan generates a fluid flow that is transported through the at least one flow channel system to the surface of the web-shaped material for the levitated guidance thereof. The device is characterized in that at least one additional radial fan for increasing the pressure in the fluid flow is arranged in the at least one flow channel system downstream of the at least one first radial fan referred to the fluid flow direction.

### CROSS-REFERENCE TO RELATED APPLICATIONS

This application is a National Phase Application of International Application No. PCT/EP2007/061819, filed on Nov. 2, 2007, which claims the benefit of and priority to German patent application no. DE 10 2006 052 521.3, filed on Nov. 6, 2006, and German patent application no. DE 10 2006 056 518.5, filed on Nov. 30, 2006. The disclosures of the above applications are incorporated herein by reference in their entirety.

### FIELD OF THE INVENTION

The invention pertains to a device for the levitated guidance of web-shaped material, particularly metal strips, with at least one first radial fan and with at least one flow channel system that is assigned to the at least one first radial fan, wherein the at least one first radial fan generates a fluid flow that is transported through the at least one flow channel system to the surface of the web-shaped material for the levitated guidance thereof. The invention furthermore pertains to a strip levitation furnace.

### BACKGROUND

Devices of this type have been known for quite some time from the prior art (e.g., DE-OS 29 08 348, DE 40 10 280 A1, EP 0 864 519 B1). In these devices, a fluid flow is generated by one or more radial fans and conveyed onto the web-shaped material to be treated by means of a flow channel system and a nozzle system arranged on the end thereof.

In a strip levitation furnace, a gas flow is generated in a furnace housing by means of one or more radial fans and usually conveyed onto the strip, passing through the furnace housing, from both sides by means of a flow channel system such that the gas flow guides the strip in a levitated fashion and, if applicable, heats or maintains the strip at a certain temperature. For this purpose, heating elements are arranged in the flow channel system or in the space surrounding the flow channel system and heat the gas flow to the desired process temperature by means of convection. At a very high temperature (e.g., 870° C.) the heat transfer to the gas flow is preferably realized by means of radiation.

In a number of applications, a metal strip needs to be acted upon with very high temperatures (e.g., 870° C.) and simultaneously guided in a levitated fashion. This is associated with the problem that the treatment gas only has a very low density at the aforementioned temperatures and consequently a low carrying power, wherein this aspect is extraordinarily problematic, in particular, when processing heavy metal strips such as, e.g., copper strips with a material thickness >2 mm. In order to compensate the loss of carrying power associated with an increase of the gas temperature, it is necessary to increase the peripheral speed of the radial fans used to such a degree that the stresses occurring on the individual fan blades significantly exceed the limiting stresses permissible at the given high temperatures even for high-temperature resistant materials such as, for example, Iconel® and a deformation of the fan blades occurs. The maximum peripheral speed of the radial fans resulting from these limiting stresses therefore usually does not suffice for guiding heavy metal strips in a levitated fashion at high temperatures, namely not even with optimized nozzle systems.

A device of the initially cited type for the levitated guidance of web-shaped material, preferably metal strips, is described in EP 0 864 519 A1, wherein the material strip to be treated is horizontally guided through the device and subjected to gas flows from both sides, i.e., from the top and from the bottom. For this purpose, one radial fan is respectively provided on each side of the material strip and generates a fluid flow that is transported to the surface of the material strip by means of an assigned flow channel system.

U.S. Pat. No. 5,118,366 describes another device for the levitated guidance of metal strips. In this device, the metal strip is only subjected to a gas flow from one side, i.e., from the bottom. For this purpose, a number of levitation nozzle boxes are arranged underneath the metal strip. Furthermore, a fan is provided in a common gas supply line in order to ensure a continuous circulation of the treatment gas. A separate supply line for each nozzle box branches off the central supply line and contains another fan stage in order to increase the pressure of the circulated treatment gas to the desired value.

### SUMMARY OF THE INVENTION

Consequently, in general, an aspect of the invention is to provide a device of the initially cited type for the levitated guidance of web-shaped material, particularly metal strips, that is also suitable for the treatment of heavy metal strips at very high temperatures.

According to an embodiment of the invention, this aspect is attained with a device for the levitated guidance of web-shaped material, particularly metal strips, namely in that at least one additional radial fan for increasing the pressure in the fluid flow is arranged in the at least one flow channel system downstream of the at least one first radial fan referred to the fluid flow direction, wherein
a) the device comprises, if the web-shaped material is substantially guided horizontally, the first radial fan and a flow channel system with an additional radial fan in order to act upon the underside of the web-shaped material with a fluid flow, wherein another flow channel system for acting upon the upper side of the web-shaped material is provided and branches off the first flow channel system upstream of the additional radial fan referred to the flow direction,
   or wherein
b) the first radial fan is provided as a first pressure stage, wherein the fluid flow generated by the first radial fan flows into two flow channel systems that respectively act upon one side of the web-shaped material with the fluid flow, wherein an additional radial fan is provided in each of the two flow channel systems as a second pressure stage, and wherein the first radial fan is centrally arranged in the device adjacent to the web-shaped material being transported through the device and the two flow channel systems are arranged point symmetric relative to one another.

The inventive solution that, in principle, is already known from the centrifugal pump technology, but represents a novelty in the field of industrial furnaces, now makes it possible to generate a fluid flow that is subjected to a multistage pressure increase and the ultimate pressure of which is sufficiently high for also reliably guiding heavy web-shaped material in a levitated fashion at high and extreme temperatures. A first partial pressure that by itself does not suffice for the levitated guidance of a heavy web-shaped material is generated in the first radial fan, wherein the blades of the radial fan are not yet excessively stressed structurally at this pressure. This first partial pressure serves as supply pressure for the additional radial fan provided in accordance with the invention. The pressure in the fluid flow is additionally increased in this additional radial fan. The pressure of the fluid flow can be increased even further, if so required, with other radial fans that are arranged in the flow channel system downstream of the additional radial fan referred to the flow direction. The objective always consists of achieving a pressure that suffices for reliably guiding the web-shaped material in a levitated fashion. In this case, it is provided that the fan speeds of the individual radial fans required for the respective pressure increase permanently lie below the previously specified material-dependent limiting speed, at which the limiting stresses on the fan blades are exceeded.

The inventive device therefore makes it possible to generate pressures that are sufficiently high for also reliably guiding heavy web-shaped material in a levitated fashion at maximum treatment temperatures with altogether limited technical expenditures.

The web-shaped material to be guided in a levitated fashion can be guided through the inventive device in different orientations. The web-shaped material preferably is essentially guided through the device horizontally and accordingly acted upon with the fluid flow from the bottom or from the bottom and from the top. It is also possible to guide the web-shaped material through the device in an inclined fashion.

If the web-shaped material is essentially guided horizontally, it is proposed that the device comprises a first radial fan and a flow channel system with an additional radial fan for acting upon the underside of the web-shaped material with the fluid flow, wherein another flow channel system is provided for acting upon the upper side of the web-shaped material and branches off the first flow channel system upstream of the additional radial fan referred to the flow direction. The above-described construction of the inventive device provides that the fluid flow acts upon the underside of the web-shaped material with a particularly high pressure in order to generate a carrying power on the surface thereof that is directed opposite the weight. The fluid flow directed toward the upper side of the web-shaped material acts thereupon with a significantly lower pressure and primarily serves for balancing the levitated guidance with the cumulative fluid flow.

Alternatively, the invention proposes that a first radial fan is provided as a first pressure stage, wherein the fluid flow generated by the first radial fan flows into two flow channel systems that respectively act upon one side of the web-shaped material with the fluid flow, and wherein an additional radial fan is provided in each of the two flow channel systems as a second pressure stage. A reliable levitated guidance of the web-shaped material can also be achieved with this construction regardless of its orientation in the device. An optimal economy of space is achieved in the inventive device in that the first radial fan is centrally arranged in the device adjacent to the web-shaped material being transported through the device, and in that the two flow channel systems are arranged point symmetric relative to one another.

In order to generate the very high temperatures in the device, another embodiment of the invention proposes that the device comprises at least one heating element for heating the fluid flow. This heating element may be arranged within the flow channel system or in the suction zone surrounding the flow channel system. The heating element is preferably realized in the form of a jacketed jet heating tube. This heating tube advantageously extends transverse to the transport direction of the web-shaped material and parallel to its surface.

According to the invention, the above-defined aspect is also attained with a strip levitation furnace for the heat treatment of web-shaped material, particularly metal strips, that comprises at least one device (i.e., a device for the levitated guidance of web-shaped material) according to an embodiment of the invention. If several devices are provided, they are preferably arranged successively referred to the transport direction of the web-shaped material. These devices may form individual heating zones (with heating elements) and cooling sections (without heating elements).

### BRIEF DESCRIPTION OF THE DRAWINGS

The invention is described in greater detail below with reference to embodiments illustrated in the drawings.

In these drawings:

FIG. 1 shows a device for the levitated guidance of metal strips in the form of a side view;

FIG. 2 shows the device according to FIG. 1 in the form of a cross section along the line II-II, and

FIGS. 3a, b show highly schematic representations of two embodiments of the inventive device.

### DETAILED DESCRIPTION

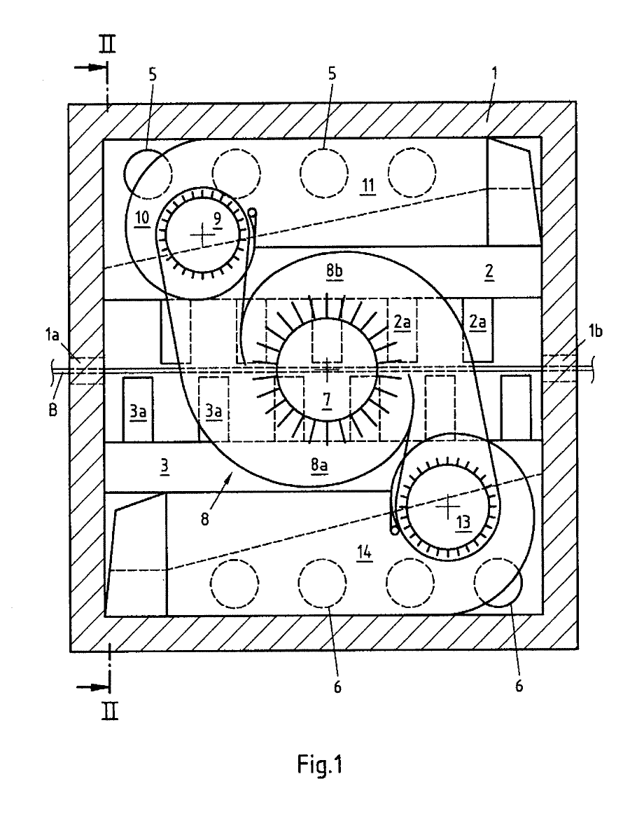

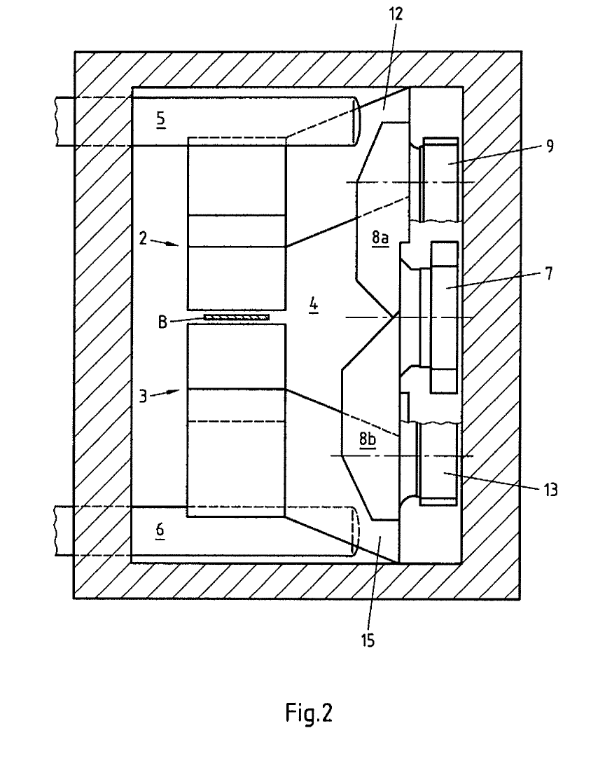

FIG. 1 shows an inventive device for the levitated guidance of web-shaped material. This device comprises a cuboid housing 1 with an inlet slot 1a and an inlet slot 1b, through which a heavy metal strip B to be treated is respectively guided into and out of the device. During its passage through the device, the metal strip B is acted upon with a treatment gas flow by an upper and a lower nozzle assembly 2, 3 and thusly guided in a levitated fashion. In this case, the nozzle assemblies 2, 3 respectively comprise a number of nozzle ribs 2a, 3a, from which the gas is ejected onto the strip B, as well as outflow channels 2b, 3b that are respectively arranged between two nozzle ribs 2a, 3a and through which the gas flows reflected on the strip surfaces flow back into a suction zone 4 (see FIG. 2). According to FIG. 2, the suction zone 4 is arranged to both sides of the levitation nozzle assemblies and extends over the entire length of the device.

In the device illustrated in FIGS. 1 and 2, the metal strip B being guided through the device in a levitated fashion is simultaneously heat-treated. For this purpose, four heating elements that are realized in the form of jacketed jet heating tubes 5, 6 are respectively arranged in the suction zone 4 above and underneath the levitation nozzle assemblies 2, 3 in order to heat the treatment gas after it flows off the strip surface.

The pressure in the treatment gas flow needs to be sufficiently high for also guiding heavy strips such as, for example, copper strips with a thickness >2 mm in a levitated fashion at very high temperatures (e.g., 870° C.) and is generated in the inventive device in a multistage fashion by means of radial fans that are successively arranged in the flow channel system. In the embodiment shown, a first radial fan 7 is provided as a first pressure stage and, according to the side view shown in FIG. 1, arranged centrally in the device adjacent to the metal strip B being transported through the device (see FIG. 2). The gas flow generated by the first radial fan 7 flows into two flow channel systems that are arranged point symmetric relative to one another as illustrated in FIG. 1 and described in greater detail below.

The first radial fan 7 is arranged, in particular, in a spiral housing 8 that is divided into a lower semi-helix 8a and an upper semi-helix 8b. The partial gas flow accelerated in the lower semi-helix 8a flows upward and into the intake 9a of an additional radial fan 9 that, according to the invention, is arranged in the upper flow channel system downstream of the first radial fan 7 as shown in FIG. 1. This fan is preferably realized in the form of a spool rotor. At this location, the gas flow is accelerated further in a 360° spiral housing 10 and then flows with an additionally increased pressure into a straight channel section 11, from where it is conveyed to the opposite end wall of the housing 1. The partial gas flow is deflected by 90° at this location and then conveyed through the obliquely extending channel section 12 until it reaches the nozzle assembly 2, from which it is ejected onto the strip surface.

The partial gas flow accelerated in the upper semi-helix 8b of the spiral housing 8 by the first radial fan 7 analogously flows downward into an additional radial fan 13 that is arranged in the lower flow channel system downstream of the first radial fan 7 referred to the flow direction and preferably also realized in the form of a spool rotor. After the partial gas flow is accelerated further and its pressure is additionally increased, it flows into the lower nozzle assembly 3 through the flow channel sections 14, 15.

At a gas temperature that amounts, for example, to 870° C. in the present embodiment, the first radial fan 7 generates a gas flow with a pressure of 1500 Pa. The spiral housing 8 divides this gas flow into two partial gas flows, the pressure of which is additionally increased, for example, to 3000 Pa by means of the radial fans 9, 13 that are arranged in the two flow channel systems downstream of the first radial fan 7 referred to the flow direction. Consequently, it is also possible to guide heavy strips in a levitated fashion in the described device according to the invention without risking a deformation of the fan blades due to an excessively high peripheral speed of an individual radial fan.

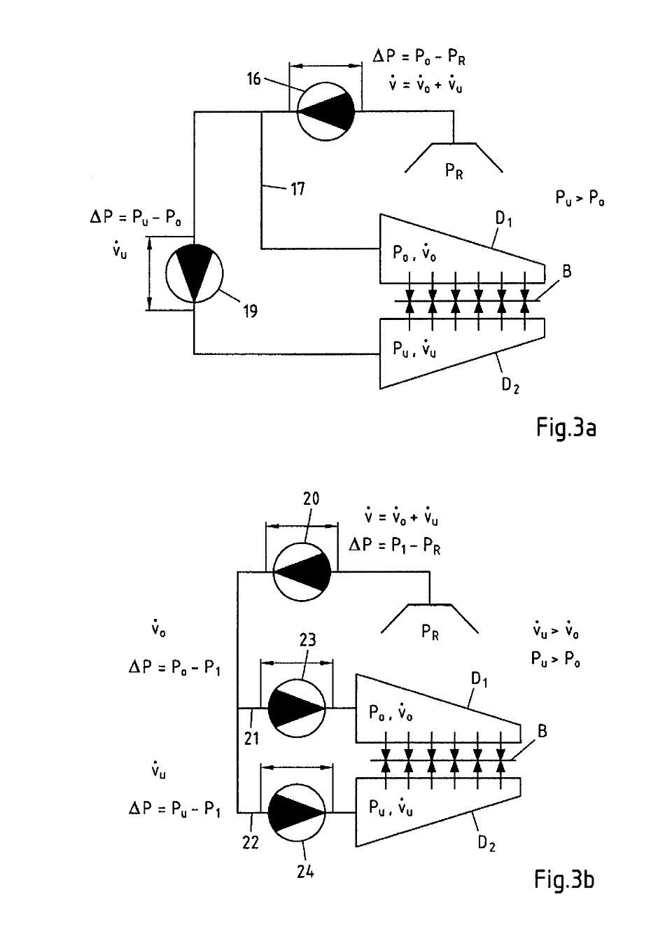

FIG. 3a schematically shows another flow concept of an inventive device for the levitated guidance of web-shaped material. In this case, a first radial fan 16 takes in a gas with an ambient pressure P_{R} and accelerates this gas to a volumetric flow rate v. The pressure in the radial fan 16 is simultaneously increased by a value ΔP to a value Pₒ. The flow channel system is split into a first and a second flow channel branch 17, 18 downstream of the flow outlet of the radial fan 16, wherein a first partial gas flow directly flows to a nozzle assembly D₁ arranged above the metal strip B to be guided in a levitated fashion through the first branch 17. The partial gas flow is ejected from this nozzle assembly onto the metal strip B from above with a pressure Pₒ and a volumetric flow rate vₒ. Another partial gas flow is conveyed to another radial fan 19 that is arranged in the second flow channel branch 18. In this radial fan, the pressure of the partial gas flow is increased to a value Pᵤ that is higher than Pₒ. This partial gas flow flows into a nozzle assembly D₂ arranged underneath the metal strip B with the increased pressure Pᵤ and a volumetric flow rate vᵤ and is then ejected onto the underside of the metal strip B. In the device schematically illustrated in FIG. 3a, two partial gas flows are generated that act upon the metal strip B from above and from below, wherein the lower partial gas flow has a higher pressure than the upper partial gas flow in order to compensate the downwardly acting weight of the metal strip B.

The device schematically illustrated in FIG. 3b corresponds to the device shown in FIGS. 1 and 2. In this case, a gas flow with the pressure P₁ is generated by a first radial fan 20. Downstream of the first radial fan 20, the gas flow is divided into two partial gas flows that are respectively conveyed to an additional radial fan 23, 24 in separate flow channel systems 21, 22. An additional pressure increase takes place in these radial fans 23, 24 such that the two partial gas flows flow into the nozzle assemblies D1 and D2 with additionally increased pressures Pₒ and Pᵤ and are then ejected onto the surface of the metal strip B. In this case, the pressure Pᵤ of the lower partial gas flow is higher or equal to the pressure Pₒ of the upper partial gas flow, but the volumetric flow rate vᵤ of the lower partial gas flow is higher than the volumetric flow rate vₒ of the upper partial gas flow.

1. A device for the levitated guidance of web-shaped material, with at least one first radial fan and with at least one flow channel system that is assigned to the at least one first radial fan, wherein the at least one first radial fan generates a fluid flow that is transported through the at least one flow channel system to the surface of the web-shaped material for the levitated guidance thereof,
wherein
at least one additional radial fan for increasing the pressure in the fluid flow is arranged in the at least one flow channel system downstream of the at least one first radial fan referred to the fluid flow direction,
wherein
a) the device comprises, if the web-shaped material is substantially guided horizontally, the at least one first radial fan and the at least one flow channel system with the at least one additional radial fan in order to act upon the underside of the web-shaped material with the fluid flow, wherein another flow channel system for acting upon the upper side of the web-shaped material (B) is provided and branches off the at least one flow channel system upstream of the at least one additional radial fan (19) referred to the flow direction,
or wherein
b) the at least one first radial fan is provided as a first pressure stage, wherein the fluid flow generated by the at least one first radial fan flows into two flow channel systems that respectively act upon one side of the web-shaped material with the fluid flow, wherein the at least one additional radial fan is provided in each of the two flow channel systems as a second pressure stage, and wherein the at least one first radial fan is centrally arranged in the device adjacent to the web-shaped material being transported through the device and the two flow channel systems are arranged point symmetric relative to one another.

2. The device according to claim 1, wherein
the at least one additional radial fan is realized in the form of a spool rotor.

3. The device according to claim 1, wherein
the web-shaped material is substantially guided through the device horizontally.

4. (canceled)

5. The device according to claim 1, wherein
the device comprises at least one heating element for heating the fluid flow.

6. The device according to claim 5, wherein
the heating element is realized in the form of a jacketed jet heating tube.

7. The device according to claim 6, wherein
the jacketed jet heating tube extends transverse to the transport direction of the web-shaped material and parallel to surface of the web-shaped material.

8. A strip levitation furnace for the heat treatment of web-shaped material, particularly metal strips, comprising at least one device according to claim 1.
